(19) United States
(12) Patent Application Publication
(10) Pub. No.: US 2020/0055608 A1
(43) Pub. Date: Feb. 20, 2020

(54) PARACHUTE SYSTEM, SAFETY PROTECTION METHOD AND DEVICE OF UNMANNED AERIAL VEHICLE

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Yong SUN, Beijing (CN); Yanguang LIU, Beijing (CN); Yun WANG, Beijing (CN); Shiqian YU, Beijing (CN); Guiyong PENG, Beijing (CN); Huaxiang LIU, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/486,692

(22) PCT Filed: Jan. 11, 2018
(86) PCT No.: PCT/CN2018/072263

§ 371 Date: Aug. 16, 2019

(30) Foreign Application Priority Data
Feb. 20, 2017 (CN) 201710089288.8

(51) Int. Cl. B64D 17/58; B64C 39/02; B64D 17/80; G01C 5/00; G01C 9/00; G01P 3/64

(52) U.S. Cl. CPC B64D 17/58; B64C 39/024; B64D 17/80; B64C 2201/185; G01C 9/005; G01P 3/64; G01C 5/005

(57) ABSTRACT

A parachute system and a safety protection method of an unmanned aerial vehicle (UAV), and relates to the technical field of intelligent storage. The parachute system of the UAV includes: a sensor configured to detect the flight state of the UAV, a parachute; and a controller electrically connected with the sensor and the parachute, respectively, and configured to obtain the flight state of the UAV from the sensor, and control the parachute to open when the UAV is in an unstable state.

### CROSS-REFERENCE TO RELATED APPLICATIONS

This application is based on and claims the benefit of priority to the Chinese patent application No. 201710089288.8 filed on Feb. 20, 2017, which is hereby incorporated by reference in its entirety into the present application.

### TECHNICAL FIELD

The disclosure provides a parachute system and a safety protection method of an unmanned aerial vehicle (UAV), and relates to the technical field of intelligent storage. The parachute system of the UAV includes: a sensor, a controller and a parachute; wherein the controller is electrically connected with the sensor and the parachute, respectively, and the sensor is used for detecting a flight state of the UAV, and the controller is used for obtaining the flight state of the UAV from the sensor, and controlling the parachute to open when the UAV is in an unstable state, thereby improving the safety of the UAV.

### BACKGROUND

A logistics UAV needs to complete entire procedures of autonomous delivery of goods from a town delivery station to a village promoter. Therefore, UAVs have very high safety requirements.

By improving the hardware reliability, the software reliability, the algorithm reliability or the structure reliability of the UAV system, the reliability of the UAV system can be ensured to a certain extent, and the flight safety of the UAV in the entire procedures of delivery process is improved.

### SUMMARY

The inventors realize that as the logistics UAV flies beyond visual range, the flight environment is complex, and unknown and undesired external interference exists. The interference of the flight environment can be resisted to a certain extent by improving the robustness of the flight control system, so that the UAV may keep flying stably. However, if the interference of the flight environment exceeds the control capability of the flight control system, the interference of the flight environment cannot be resisted no matter how strong the capability of the control system is. In the case that the interference of the flight environment exceeds the control capacity of the flight control system, how to improve the safety of the UAV and reduce the damage and loss caused by the instability of the UAV is a problem to be solved urgently at present.

One technical problem solved by this disclosure is how to improve the safety of the UAV.

According to one aspect of the embodiments of the present disclosure, a parachute system of an unmanned aerial vehicle (UAV) is provided, comprising: a sensor, a controller and a parachute; wherein the controller is electrically connected with the sensor and the parachute, respectively, and the sensor is configured to detect a flight state of the UAV, and the controller is configured to obtain the flight state of the UAV from the sensor, and control the parachute to open when UAV is in an unstable state.

In some embodiments, the controller is further configured to: wait for a first preset time when the UAV is in the unstable state, and control the parachute to open if a flight control system still fails to detect the instability of the UAV after reaching the first preset time.

In some embodiments, the controller is further configured to: detect a height of the UAV relative to aground and control the sensor to be turned on when the height of the UAV relative to the ground is greater than a preset height.

In some embodiments, the sensor is configured to detect a pitch angle and a roll angle of the UAV; and the controller is configured to determine whether an arithmetic square root of a sum of squares of the pitch angle and the roll angle of the UAV is greater than or equal to a preset angle or not, and determine that the UAV is in an unstable state when the arithmetic square root is greater than or equal to the preset angle; or, the sensor is configured to detect a height of the UAV; and the controller is configured to determine whether a rate of change of the height of the UAV is greater than a preset value or not, and determine that the UAV is in an unstable state when rate of change of the height of the UAV is greater than the preset value.

In some embodiments, the controller is further configured to control a propeller to stop rotating and control the parachute to open after an interval of a second preset time.

According to another aspect of the embodiments of the present disclosure, a control system of a UAV is provided, comprising a flight control system and a parachute system of the UAV according to any one of claims 1 to 5. The flight control system is configured to control the parachute to open when detecting that the UAV is in an unstable state.

According to still another aspect of the embodiments of the present disclosure, a safety protection method of an UAV is provided, wherein the safety protection method comprises: a parachute system detects a flight state of the UAV; the parachute system control a parachute to open when the UAV is in an unstable state.

In some embodiments, controlling a parachute to open by the parachute system when the UAV is in an unstable state comprises: waiting for a first preset time when the UAV is in an unstable state, and controlling the parachute to open by the parachute system if a flight control system still fails to detect the instability of the UAV after reaching the first preset time.

In some embodiments, detecting a flight state of the UAV by the parachute system comprises: detecting a height of the UAV relative to the ground by the parachute system; detecting a flight state of the UAV when the height of the UAV relative to the ground is greater than a preset height.

In some embodiments, detecting a flight state of the UAV by the parachute system comprises: detecting a pitch angle and a roll angle of the UAV by the parachute system; determining whether a arithmetic square root of the sum of squares of the pitch angle and the roll angle of the UAV is greater than or equal to a preset angle or not, and determining that the UAV is in an unstable state by the parachute system when the arithmetic square root is greater than or equal to the preset angle; or, detecting a height of the UAV by the parachute system; determining whether a rate of change of the height of the UAV is greater than a preset value or not, and determining that the UAV is in an unstable state by the parachute system when the rate of change of the height of the unmanned aerial vehicle is greater than the preset value.

In some embodiments, controlling a parachute to open by the parachute system when the UAV is in an unstable state comprises: controlling a propeller to stop rotating and controlling the parachute to open by the parachute system after an interval of a second preset time.

In some embodiments, the safety protection method further comprises: controlling the parachute to open by the flight control system when detecting that the UAV is in an unstable state.

According to still another aspect of the embodiments of the present disclosure, a safety protection device of a UAV is provided, comprising: a memory; and a processor coupled to the memory, which is configured to execute the safety protection method of the UAV based on the instructions stored in the memory.

According to still another aspect of the embodiments of the present disclosure, a computer-readable storage medium is provided, wherein the computer-readable storage medium stores computer instructions which, when executed by a processor, implement the safety protection method of a UAV.

The parachute system of a UAV in this disclosure can detect the flight state of the UAV independently from the flight control system and control the parachute to open when the UAV is in a unstable state, thus improving the safety of the UAV.

Further features of the present disclosure, as well as advantages thereof, will become clearer from the following detailed description of exemplary embodiments of the present disclosure with reference to the accompanying drawings.

### BRIEF DESCRIPTION OF THE DRAWINGS

To explain the embodiments of the present disclosure or the technical solutions in the prior art more clearly, a brief introduction will be given below for the drawings required in the description of the embodiments or the prior art. Apparently, the drawings illustrated as follows are merely some of the embodiments of the present disclosure. An ordinary person skilled in the art may also acquire other drawings according to such drawings without paying any inventive effort.

FIG. 1 shows a schematic structural diagram of some embodiments of a parachute system of a UAV of the present disclosure.

FIG. 2 shows a schematic structural diagram of some embodiments of a control system of a UAV of the present disclosure.

FIG. 3 shows a flow chart illustrating some embodiments of the safety protection method of a UAV of the present disclosure.

FIG. 4 shows a flow chart illustrating other embodiments of the safety protection method of a UAV of the present disclosure.

FIG. 5 shows a structural diagram illustrating some embodiments of the safety protection device of a UAV of the present disclosure

FIG. 6 shows a structural diagram illustrating other embodiments of the safety protection device of a UAV of the present disclosure.

### DETAILED DESCRIPTION

The technical solutions in the embodiments of the present disclosure will be clearly and completely described below with reference to the drawings of the embodiments of the present disclosure. Obviously, the described embodiments are just a part, instead of all, of the embodiments of the present disclosure. The following description of at least one of the exemplary embodiments is actually merely illustrative, and is not meant to be limitation on the present disclosure and its application or use in any way. All other embodiments obtained by persons of ordinary skill in the art based on the embodiments of the present disclosure without paying creative efforts are within the protection scope of the present disclosure.

The inventors analyze the process of opening the parachute by the UAV in the prior art. In the prior art, a flight control system detects a flight state of a UAV by means of a sensor of the flight control system itself. When the flight control system determines that the UAV is in an unstable state, the flight control system controls the parachute to open. However, the way that the UAV opens the parachute in the prior art has a hidden danger of safety. On one hand, a sensor of the flight control system may fail, or a large error may occur in the detection process, so that the flight control system cannot accurately determine that the UAV is in an unstable state; on the other hand, even if the sensor of the flight control system accurately determines that the UAV is in an unstable state, the flight control system may still fail to open the parachute timely.

Based on the analysis, the inventors innovatively design a parachute system of a UAV. The parachute system of the UAV can detect a flight state of the UAV independently from the flight control system and control the parachute to open when the UAV is in a unstable state, thus improving the safety of the UAV.

Some embodiments of the parachute system of a UAV provided by the present disclosure are described below with reference to FIG. 1.

FIG. 1 shows a schematic structural diagram of some embodiments of a parachute system of a UAV of the present disclosure. As shown in FIG. 1, the parachute system of the UAV in these embodiments includes: a sensor 102, a controller 104, and a parachute 106, wherein the controller 104 is electrically connected with the sensor 102 and the parachute 106, respectively, and the sensor 102 is configured to detect a flight state of the UAV. The direction of the sensor 102 can be aligned with the direction of the sensor of the flight control system such that the indicator detected by the sensor 102 is the same as the indicator detected by the sensor of the flight control system. The controller 104 is configured to obtain the flight state of the UAV from the sensor 102 and control the parachute to open when the UAV is in an unstable state.

The operation process of the parachute system of the UAV 10 is as follows:

(1) the controller 104 detects a height of the UAV relative to a ground and controls the sensor 102 to be turned on when the height of the UAV relative to the ground is greater than a preset height.

For example, the controller may control sensor to be turned on when the height of the UAV relative to the ground is greater than 10 m. The purpose that the controller controls the turning on of the sensor according to the height of the UAV relative to the ground is to prevent the controller from misjudging that the UAV is in an unstable state. During the transfer of the UAV near the ground, the state of the UAV's fuselage may be different from that during the steady flight; the rate of change of the height of the UAV is greater during an autonomous rising or descending process. If the sensor is in an on state, the controller may misjudge that the UAV is in an unstable state.

(2) The sensor 102 detects a flight state of the UAV.

For example, the sensor 102 may detect a pitch angle and a roll angle of the UAV. For another example, the sensor 102 may detect a height of the UAV.

(3) The controller 104 obtains the flight state of the UAV from the sensor 102 and determines whether the UAV is in an unstable state.

For instance, the controller may determine whether an arithmetic square root of the sum of squares of the pitch angle and the roll angle of the UAV is greater than or equal to a preset angle or not, and determine that the UAV is in an unstable state when the arithmetic square root is greater than or equal to the preset angle. That is, the logic of the controller for determining the instability of the UAV can be formula (1):

\sqrt{φₚ²γₚ²}≥70° (1)

wherein φₚ is the pitch angle of the UAV acquired by the sensor 102, and γₚ is the roll angle of the UAV acquired by the sensor 102.

Alternatively, the controller may determine whether the rate of change of the height of the UAV is greater than a preset value or not, and determine that the UAV is in an unstable state when the rate of change of the height is greater than the preset value. That is, the logic of the controller for determining the instability of the UAV can be formula (2):

Δ\dot{H}ₚ>10 m/s (2)

wherein Δ\dot{H}ₚ is a rate of change of the height calculated by the controller according to the height acquired by the sensor 102.

Optionally, the controller 104 may determine continuously within a continuous time period of 0.3 s. When one of the formulas (1) or (2) is satisfied within 0.3 s, the controller 104 determines that the UAV is unstable. Those skilled in the art will appreciate that the sensor 102 may collect other state indicators of the UAV, and the controller may use a combination of the state indicators as logic for determining instability of the UAV.

(4) The controller 104 controls the parachute to open.

After determining that the UAV is in an unstable state, the controller may first control the propeller to stop rotating and control the parachute to open after an interval of a certain time period (such as 0.2 seconds). The parachute is opened after the propeller is controlled to stop rotating, so that the interference of the propeller to the parachute in the opening process can be effectively avoided, and safe opening of the parachute is ensured

In some embodiments, the controller may wait for a period of time (e.g., 0.5 seconds) after determining that the UAV is in an unstable state. During this time period, the flight control system detects the flight state of the UAV. If the flight control system also detects that the UAV is in an unstable state, the flight control system may control the parachute to open. If the flight control system still does not detect the instability of the UAV after reaching 0.5 seconds, the controller controls to open the parachute.

In the above embodiment, the parachute system can detect the flight state of the UAV independently from the flight control system and control the parachute to open when the UAV is in a unstable state, thus improving the safety of the UAV.

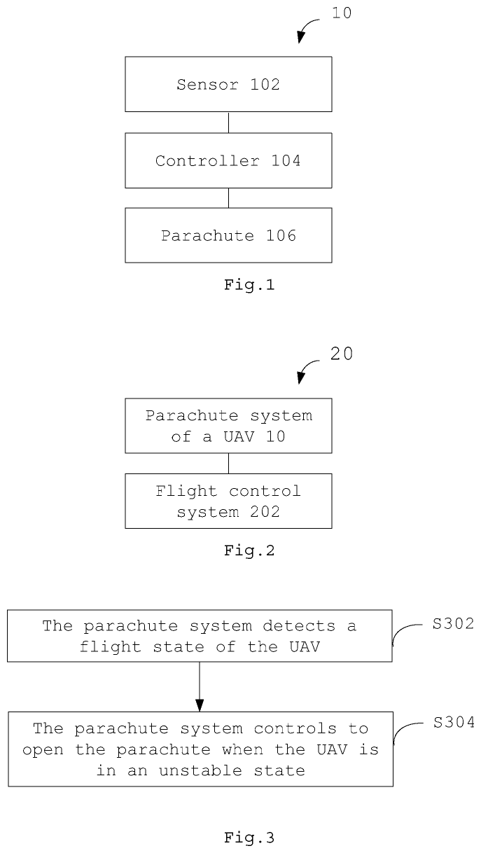

Some embodiments of a control system of a UAV provided by the present disclosure are described below with reference to FIG. 2.

FIG. 2 shows a schematic structural diagram of some embodiments of a control system of a UAV in the present disclosure. As shown in FIG. 2, the control system of the UAV 20 in these embodiments comprises a parachute system of the UAV 10 and a flight control system 202. Wherein the flight control system 202 and the parachute system of the UAV 10 communicate with each other through a serial port, and the flight control system 202 is configured to control the parachute to open when detecting that the UAV is in an unstable state.

For example, when the parachute system of the UAV 10 determines that the UAV is unstable, the parachute system of the UAV 10 sends a command that “the parachute system detects the instability of the UAV” to the flight control system 202. Within 0.5 s after that, if the command that “the flight control system detects the instability of the UAV” sent by the flight control system is still not received, the parachute system of the UAV 10 sends an “open the parachute” command to the flight control system 202 through a serial port, and the flight control system 202 stops the rotation of the propeller after receiving the command of “open the parachute”, and controls the parachute to open after 0.2 s.

In the above embodiment, it can be seen that, in the control system of the UAV, the parachute system of the UAV and the flight control system are two systems independent from each other. The parachute system of the UAV and the flight control system can both detect the flight state of the UAV independently from each other, and they can also control the parachute to open independently from each other, thus improving the safety of the UAV.

The embodiment shown in FIG. 1 has described the state detection of the UAV and the parachute opening process in detail from the side of the parachute system of the UAV 10. The following content describes the state detection of the UAV and the parachute opening process from the side of the flight control system 202 with reference to FIG. 3, which specifically includes the following steps:

(1) The flight control system detects the state of the UAV by means of a sensor of the flight control system itself to determine whether the UAV is unstable or not.

Wherein when UAV is near the ground, the flight control system does not determine whether UAV is in unstable state. After the UAV takes off, when the height relative to the ground is greater than 10 meters, the flight control system determines whether the UAV is in an unstable state or not, and sends a message of “start the state detection” to the parachute system of the UAV 10 through a serial port. After receiving the instruction signal, the parachute system starts the logic for determining the instability of the UAV.

Wherein the logic that the flight control system determines the instability of the UAV may be formula (3) or (4),

\sqrt{Δφ₁²+Δγ₁²}≥70° (3)

Δ\dot{H}₁>10 m/s (4)

wherein Δφ₁ is a pitch angle deviation of the UAV calculated by the flight control system, Δγ₁ is a roll angle deviation of the UAV calculated by the flight control system, and Δ\dot{H}₁ is a rate of change of the height of the UAV calculated by the flight control system.

Similarly, the flight control system determines continuously within a continuous time period of 0.3 s, and when one of the formulas (3) or (4) is satisfied within 0.3 s, the flight control system determines that the UAV is unstable.

(2) When detecting that the UAV is in an unstable state, the flight control system controls to open the parachute.

When the UAV works stably, the flight control system does not send a control command to the parachute system through a serial port. When the flight control system determines that the UAV is unstable, the parachute system continues to determine whether the UAV is in an unstable state. If the flight control system receives a command of “the parachute system detects the instability of the UAV” sent by the parachute system, namely, the flight control system and the parachute determine the instability of the UAV at the same time, the flight control system sends a command of the propeller stopping rotating and sends a command of “open the parachute” at an interval of 0.2 s to execute the parachute opening operation.

If the flight control system does not receive a command of “the parachute system detects the instability of the UAV” sent by the parachute system within 0.5 s after determining the instability of the UAV, the flight control system sends a command of the propeller stopping rotating and sends a command of “open the parachute” at an interval of 0.2 s to execute the parachute opening operation.

The safety protection method of the UAV of some embodiments of the present disclosure is described below with reference to FIG. 3.

FIG. 3 shows a flow chart illustrating some embodiments of the safety protection method of a UAV in the present disclosure. As illustrated by FIG. 3, the safety protection method of the UAV of the embodiment comprises steps S302 and S304.

In step S302, the parachute system detects the flight state of the UAV.

For example, the parachute system detects a pitch angle and a roll angle of the UAV, and then determines whether an arithmetic square root of a sum of squares of the pitch angle and the roll angle of the UAV is greater than or equal to a preset angle or not, and determines that the UAV is in an unstable state when the arithmetic square root is greater than or equal to the preset angle.

For another example, the parachute system detects the height of the UAV, and then determines whether a rate of change of the height of the UAV is greater than a preset value, and determines that the UAV is in an unstable state when the rate of change of the height is greater than a preset value.

In step S304, the parachute system controls the parachute to open when the UAV is in an unstable state.

Optionally, the parachute system waits fora first preset time when the UAV is in an unstable state, and if the flight control system still does not detect the instability of the UAV after the first preset time is reached, the parachute is controlled to be opened.

Optionally, the parachute system controls the propeller to stop rotating and controls the parachute to open after an interval of a second preset time.

In the above embodiment, the parachute system can detect a flight state of the UAV independently from the flight control system and control the parachute to open when the UAV is in a unstable state, thus improving the safety of the UAV.

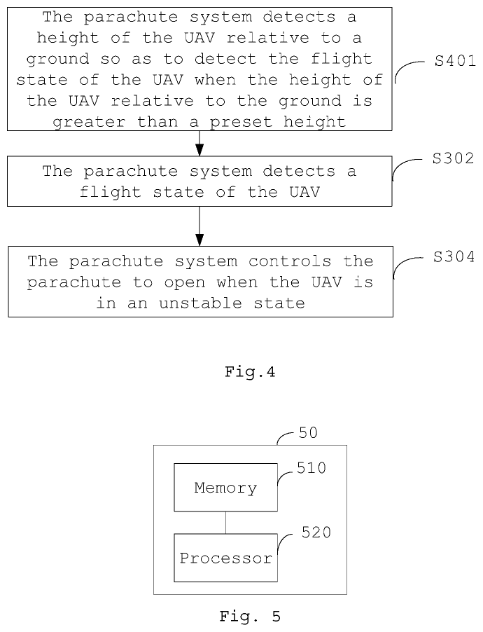

The safety protection method of the UAV of other embodiments of the present disclosure is described below with reference to FIG. 4.

FIG. 4 shows a flow chart illustrating other embodiments of the safety protection method of a UAV. As shown in FIG. 4, on the basis of the embodiment shown in FIG. 3, the safety protection method of the UAV of the embodiment further comprises:

In step S401, the parachute system detects a height of the UAV relative to a ground, so that the parachute system detects a flight state of the UAV when the height of the UAV relative to the ground is greater than a preset height.

In the above embodiment, the parachute system controls whether to start the detection of the flight state of the UAV according to the height of the UAV relative to the ground, so that the controller can be effectively prevented from misjudging that the UAV is in an unstable state.

FIG. 5 shows a structural diagram illustrating some embodiments of the safety protection device of a UAV of the present disclosure. As shown in FIG. 5, the safety protection device 50 of the UAV in the embodiments comprises: a memory 510 and a processor 520 coupled to the memory 510, wherein the processor 520 is configured to execute the safety protection method of a UAV in any of the aforementioned embodiments based on the command stored in the memory 510.

Wherein the memory 510 may include, for example, a system memory, a fixed non-volatile storage medium, or the like. The system memory stores, for example, an operating system, an application, a boot loader, and other programs.

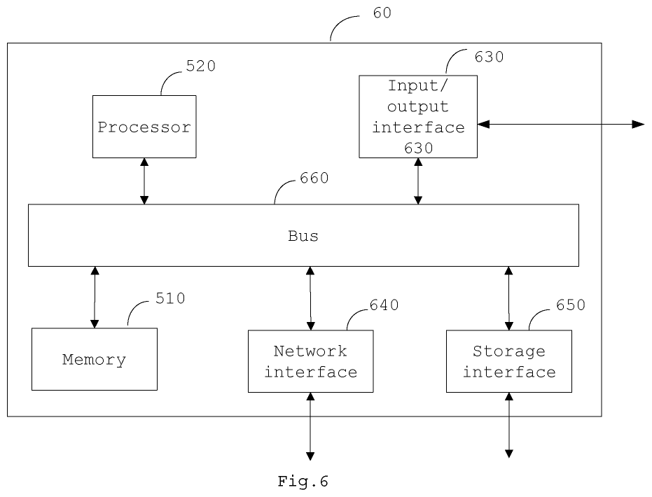

FIG. 6 shows a structural diagram illustrating other embodiments of the safety protection device of a UAV of the present disclosure. As shown in FIG. 6, the device 60 in these embodiments includes: a memory 510 and a processor 520, and may also include an input/output interface 630, a network interface 640, a storage interface 650, etc. The interfaces 630, 640, 650, the memory 510 and the processor 520 may be connected, for example, via a bus 650. Wherein the input/output interface 630 provides a connection interface for input/output devices such as a display, a mouse, a keyboard, a touch screen, and the like. The network interface 640 provides a connection interface for various networked devices. The storage interface 650 provides a connection interface for an external storage device such as an SD card or a USB flash disk, etc.

The present disclosure also includes a computer-readable storage medium, wherein the computer-readable storage medium stores computer instructions which, when executed by a processor, implement the safety protection method of a UAV in any of the aforementioned embodiments.

Those skilled in the art will appreciate that embodiments of the present disclosure may be provided as a method, system, or computer program product. Therefore, the embodiments of the present disclosure can take the form of an entirely hardware embodiment, an entirely software embodiment or an embodiment containing both hardware and software elements. Moreover, this disclosure can be in a form of one or more computer program products containing the computer-executable codes which can be implemented in the computer-executable non-transitory storage media (including but not limited to disk memory, CD-ROM, optical memory, etc.).

The present disclosure is described with reference to the flow charts and/or block diagrams of the method, device (system) and computer program product according to the embodiments of the present disclosure. It shall be understood that each flow and/or block in the flowcharts and/or block diagrams and a combination of the flows and/or blocks in the flowcharts and/or block diagrams can be implemented by computer program instructions. These computer program instructions can be provided to a general purpose computer, a special purpose computer, an embedded processor, or a processor of other programmable data processing devices so as to generate a machine for generating means for implementing the functions of one or more flows of a flowchart and/or one or more blocks of a block diagram by using the instructions executed by the computer or the processor of other programmable data processing devices.

These computer program instructions can also be stored in a computer readable memory guiding the computer or other programmable data processing devices to work in a particular way, such that the instructions stored in the computer readable memory generate an article of manufacture containing instruction means which implement the functions of one or more flows of a flowchart and/or one or more blocks in a block diagram.

These computer program instructions can also be loaded onto a computer or other programmable data processing devices such that a series of operational steps are performed on a computer or other programmable devices to produce computer-implemented processing, so that the instructions executed on a computer or other programmable devices provide steps for implementing the functions of one or more flows of a flowchart and/or one or more blocks of a block diagram.

The above content is only preferred embodiments of this present disclosure, but cannot be used for limiting this disclosure. Any modification, equivalent replacement and improvement, etc. within the spirit and principle of this disclosure shall be contained in the scope of protection of this disclosure.

1. A parachute system of an unmanned aerial vehicle, comprising:
a sensor configured to detect a flight state of the unmanned aerial vehicle;
a parachute; and
a controller electrically connected with the sensor and the parachute, respectively, and configured to obtain the flight state of the unmanned aerial vehicle from the sensor, and control the parachute to open when the unmanned aerial vehicle is in an unstable state.

2. The parachute system according to claim 1, wherein the controller is further configured to: wait for a first preset time when the unmanned aerial vehicle is in the unstable state, and control the parachute to open if a command that a flight control system detects the instability of the unmanned aerial vehicle is not received from the flight control system after reaching the first preset time.

3. The parachute system according to claim 1, wherein the controller is further configured to: detect a height of the unmanned aerial vehicle relative to a ground and control the sensor to be turned on when the height of the unmanned aerial vehicle relative to the ground is greater than a preset height.

4. The parachute system according to claim 1, wherein the sensor is configured to detect a pitch angle and a roll angle of the unmanned aerial vehicle; and the controller is configured to determine whether an arithmetic square root of a sum of squares of the pitch angle and the roll angle of the unmanned aerial vehicle is greater than or equal to a preset angle or not, and determine that the unmanned aerial vehicle is in an unstable state when the arithmetic square root is greater than or equal to the preset angle;
or,
the sensor is configured to detect a height of the unmanned aerial vehicle; and the controller is configured to determine whether a rate of change of the height of the unmanned aerial vehicle is greater than a preset value or not, and determine that the unmanned aerial vehicle is in an unstable state when the rate of change of the height of the unmanned aerial vehicle is greater than the preset value.

5. The parachute system according to claim 1, wherein the controller is further configured to control a propeller to stop rotating and control the parachute to open after an interval of a second preset time.

6. An unmanned aerial vehicle, comprising a flight control system and a parachute system of the unmanned aerial vehicle according to claim 1, wherein the flight control system is configured to control the parachute to open when detecting that the unmanned aerial vehicle is in an unstable state.

7. A safety protection method of an unmanned aerial vehicle, comprising:
detecting a flight state of the unmanned aerial vehicle by a parachute system;
controlling a parachute to open by the parachute system when the unmanned aerial vehicle is in an unstable state.

8. The safety protection method according to claim 7, wherein the controlling a parachute to open by the parachute system when the unmanned aerial vehicle is in an unstable state comprises:
waiting for a first preset time when the unmanned aerial vehicle is in an unstable state, and controlling the parachute to open by the parachute system if a command that a flight control system detects the instability of the unmanned aerial vehicle is not received from the flight control system after reaching the first preset time.

9. The safety protection method according to claim 7, wherein the detecting a flight state of the unmanned aerial vehicle by a parachute system comprises:
detecting a height of the unmanned aerial vehicle relative to a ground by the parachute system;
detecting a flight state of the unmanned aerial vehicle when the height of the unmanned aerial vehicle relative to the ground is greater than a preset height.

10. The safety protection method according to claim 7, wherein the detecting a flight state of the unmanned aerial vehicle by a parachute system comprises:
detecting a pitch angle and a roll angle of the unmanned aerial vehicle by the parachute system;
determining whether an arithmetic square root of a sum of squares of the pitch angle and the roll angle of the unmanned aerial vehicle is greater than or equal to a preset angle or not, and determining that the unmanned aerial vehicle is in an unstable state by the parachute system when the arithmetic square root is greater than or equal to the preset angle;
or,
detecting a height of the unmanned aerial vehicle by the parachute system;
determining whether a rate of change of the height of the unmanned aerial vehicle is greater than a preset value or not, and determining that the unmanned aerial vehicle is in an unstable state by the parachute system when the rate of change of the height of the unmanned aerial vehicle is greater than the preset value.

11. The safety protection method according to claim 7, wherein the controlling a parachute to open by the parachute system when the unmanned aerial vehicle is in an unstable state comprises:
controlling a propeller to stop rotating and controlling the parachute to open by the parachute system after an interval of a second preset time.

12. The safety protection method according to claim 7, wherein said safety protection method further comprises: controlling the parachute to open by the flight control system when detecting that the unmanned aerial vehicle is in an unstable state.

13. A safety protection device of an unmanned aerial vehicle, comprising:
a memory; and
a processor coupled to the memory, which is configured to execute the safety protection method of the unmanned aerial vehicle according to claim 7 based on instructions stored in the memory.

14. A computer readable non-transitory storage medium storing a computer program, when executed by a processor, causes a processor to perform one or more steps as follows:
detecting a flight state of the unmanned aerial vehicle by a parachute system;
controlling a parachute to open by the parachute system when the unmanned aerial vehicle is in an unstable state.

15. The computer readable non-transitory storage medium according to claim 14, wherein the controlling comprises:
waiting for a first preset time when the unmanned aerial vehicle is in an unstable state, and controlling the parachute to open by the parachute system if a command that a flight control system detects the instability of the unmanned aerial vehicle is not received from the flight control system after reaching the first preset time.

16. The computer readable non-transitory storage medium according to claim 14, wherein the detecting comprises:
detecting a height of the unmanned aerial vehicle relative to a ground by the parachute system;
detecting a flight state of the unmanned aerial vehicle when the height of the unmanned aerial vehicle relative to the ground is greater than a preset height.

17. The computer readable non-transitory storage medium according to claim 14, wherein the detecting comprises:
detecting a pitch angle and a roll angle of the unmanned aerial vehicle by the parachute system;
determining whether an arithmetic square root of a sum of squares of the pitch angle and the roll angle of the unmanned aerial vehicle is greater than or equal to a preset angle or not, and determining that the unmanned aerial vehicle is in an unstable state by the parachute system when the arithmetic square root is greater than or equal to the preset angle;
or,
detecting a height of the unmanned aerial vehicle by the parachute system;
determining whether a rate of change of the height of the unmanned aerial vehicle is greater than a preset value or not, and determining that the unmanned aerial vehicle is in an unstable state by the parachute system when the rate of change of the height of the unmanned aerial vehicle is greater than the preset value.

18. The computer readable non-transitory storage medium according to claim 14, wherein the controlling comprises:
controlling a propeller to stop rotating and controlling the parachute to open by the parachute system after an interval of a second preset time.

19. The computer readable non-transitory storage medium according claim 14, wherein the steps further comprise:
controlling the parachute to open by the flight control system when detecting that the unmanned aerial vehicle is in an unstable state.
